(19) United States
(12) Patent Application Publication
(10) Pub. No.: US 2007/0002807 A1
(43) Pub. Date: Jan. 4, 2007

(54) Electronic Data Transport system and Method

(75) Inventors: Richard Fletcher, Cambridge, MA (US); Amir Hasson, Cambridge, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: FIRST MILE SOLUTIONS, LLC, Cambridge, MA (US)

(21) Appl. No.: 10/908,924

(22) Filed: Jun. 1, 2005

(51) Int. Cl. H04Q 7/24

(52) U.S. Cl. 370/338

(57) ABSTRACT

A system and method for transporting audio and video messages is described. The messages are recorded and stored locally on a storage device. The recorded messages are then wirelessly transferred to a mobile roving device that physically transports the message data to another location. The messages are then wirelessly transported to a network file server that automatically dials and connects to client devices via conventional telephone, mobile phone, and IP networks. This system is capable of transporting audio and video messages in situations where real-time data connectivity is not available.

### FIELD OF THE INVENTION

The present invention relates to the transport of audio and video messages. More specifically, this invention relates to methods of transporting data that do not require the use of a real-time data network.

### BACKGROUND OF THE INVENTION

Communication via audio or video messages is a fundamental part of human culture. Examples include a simple telephone call voice mail or placing an order for goods and services. However, despite the emergence of telecommunications infrastructure, such as cellular telephones or the Internet, there are many places or many situations where it is not possible to connect to a communication network to send messages.

In most parts of the world, there are many rural areas where mobile phone networks do not exist or mobile phone service is too expensive. In developing countries, there are hundreds of millions of people who live in rural communities and lack basic communications infrastructure. This represents a need for an electronic data network that can operate in places that lack a real-time communications infrastructure. An important solution to meeting the needs of the rural world is a store-and-forward network, where the messages are recorded electronically and retrieved at a later time by the recipient. A common example of a store-and-forward communication is an electronic e-mail message or a mobile telephone voice mail message. What has been lacking, however, is a method of communication that can integrate modern Internet data transport with conventional telephone networks. More specifically, since most people in the world do not own a private telephone or have access to electronic e-mail, there is also a need for creating a communication system that can be used by people who may lack a private telephone number or e-mail address.

Although Internet or text-based communications are very popular among developed regions and more educated social groups, it is often easier and more convenient to employ audio (voice) communications or video. Furthermore, providing local language interfaces and content for these communities is complicated by the fact that written languages and dialects can vary widely within a given geographic region. In many cases, it is desirable to send and receive a simple voice mail or video mail without requiring reading literacy or computer literacy. It is interesting to note, however, that many illiterate people in developing communities do understand numeric interfaces, such as those provided on a calculator, digital watch, or telephone.

There is a need, therefore, to create a communications technology that can allow messages to be sent and received using a simple interface that most people can understand or can easily learn, such as a telephone device or numeric keypad. In addition, it is important to create an electronic data network and communications service that allows the use of existing telephone devices, which are already in widespread use throughout the world.

### SUMMARY OF THE INVENTION

The present invention is a system for transporting audio and video messages. This system integrates with existing telephone networks and devices and can be used in areas where real-time data networks do not exist or are not available.

A key aspect of the present invention is the use of physical transport means to transport messages. The audio or video messages can be recorded on client terminals in the form of conventional communication devices, such as a portable computer or telephone. A roving mobile wireless device, mounted on a motorcycle or small airplane, for example, is then used to automatically pick up the message data and deliver it to an electronic network that may be as far as a few hundred kilometers away. Modern wireless standards, such as IEEE 802.11 (Wi-Fi) enable high-bandwidth short-range communications at a very low cost and relatively low-power, which is very important for operation in rural regions.

A second key aspect of the present invention is the use of a voicemail or video-mail server that is connected to a conventional telephone network. This file server has the ability to send and receive telephone messages via common telephone networks, and this file server also has the ability to send and receive the digital messages that are physically transported to and from the remote client terminals. By integrating the telephone network with the local wireless network, the present invention allows users to send and receive telephone messages without needing to be connected to the telephone network. Thus, the file server acts as the proxy for the user and client devices that to not have access to a conventional telephone network.

In contrast to other communication technologies, such as conventional mobile phone networks or long-distance radio networks, the present invention also has the added advantage of having low power consumption and having a low cost of installation and maintenance.

### BRIEF DESCRIPTION OF THE FIGURES

FIG. 1 illustrates the basic operation of the network in the context of a rural area with several villages.

FIG. 2 describes the basic elements of the electronic data transport network that comprise the present invention. A single file server is shown. Other embodiments are possible that employ several file severs.

FIG. 3 describes an embodiment of the present invention containing two separate file servers. This illustrates how the present invention can be used to support multiple audio or video messaging servers.

FIG. 4 depicts a flow chart describing the basic process used to send a message from a client device in a remote location to a telephone device in a conventional phone network.

FIG. 5 depicts a flow chart describing the basic process used to send a message from a conventional telephone network to a client device in a remote location.

FIG. 6 depicts a more detailed example of how the message transport may be implemented in sending a message from a remote client device to a phone network device.

FIG. 7 depicts a more detailed example of how the message transport may be implemented in sending a message from a phone network device to a remote client device.

### DETAILED DESCRIPTION OF THE FIGURES

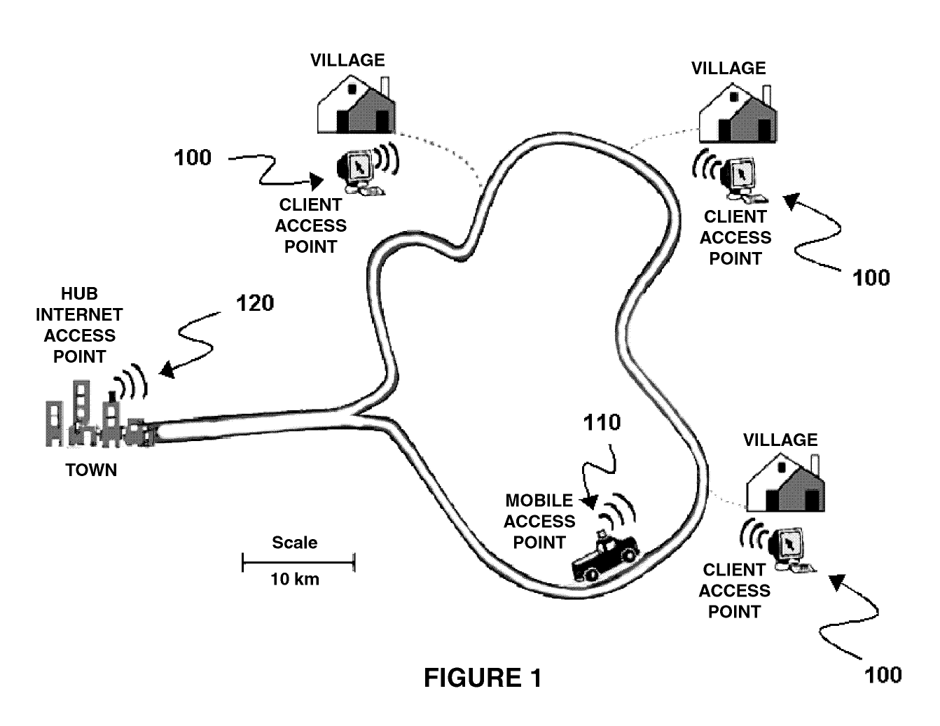

FIG. 1 depicts how the present invention can be implemented in the context of a rural area with several villages. At each village, a wireless access point 100 enables wireless communication and sharing of data within the local area of the village through the use of a wireless communication protocol, such as IEEE 802.11, commonly known as Wi-Fi. This access point also enables communication with local client devices, such as a handheld computer, that are within range of access point 100. The access point 100 may also enable communication with local devices over wire-line connectivity, such as a local area Ethernet network.

Also shown in FIG. 1 is mobile access point 110 which can be mounted on any traveling vehicle, such as a bus, motorcycle, airplane, boat, or horse, for example. As mobile access point 110 comes within range of fixed client access points 100, data is automatically exchanged as needed to send and receive new messages. The mobile access point then physically carries the message data to hub access point 120 that is electrically connected to a network computer and used to transport information over greater distances via the Internet. As the mobile access point 110 moves to other locations, the mobile access point 110 can repeat this process of physically transporting the messages among client access points 100 and hub access points, including transferring messages from one client access point 100 to another client access point 100 and from one mobile access point 110 to another mobile access point 100. Multiple mobile access points 110 may be employed in order to increase the frequency of information transfer to and from the client access points 100.

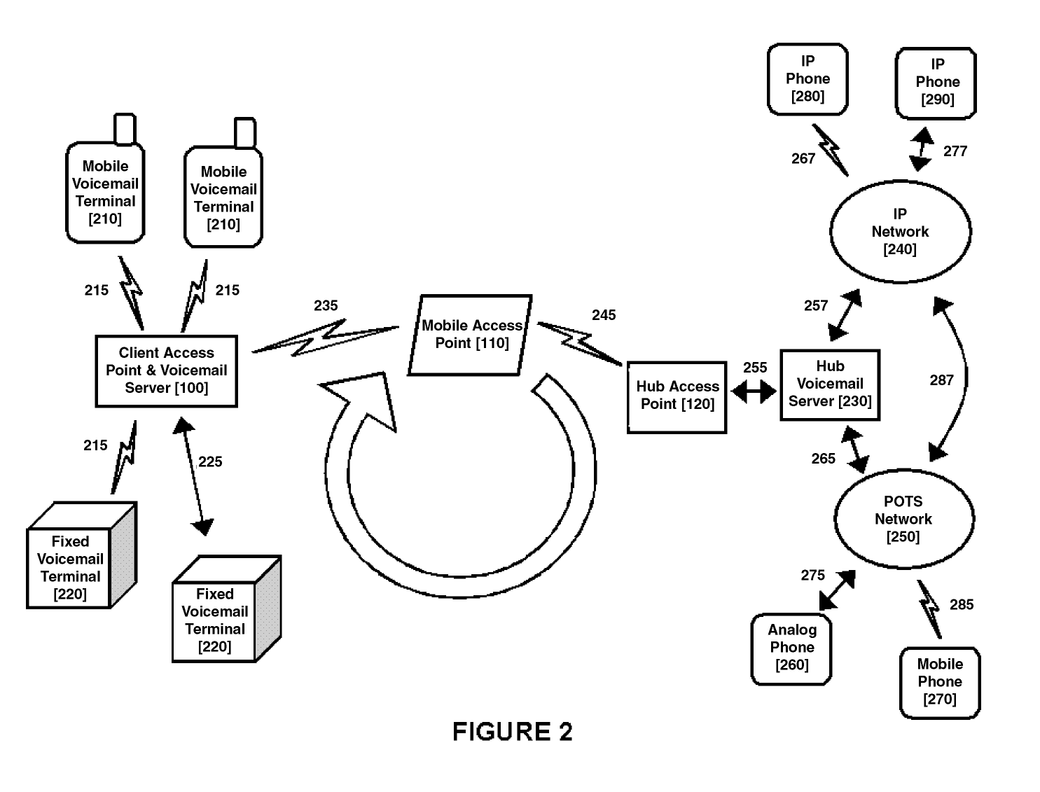

FIG. 2 describes the basic elements of the electronic data transport network that comprises the present invention. FIG. 2 shows the access point 100, mobile access point 110, and hub access point 120 previously shown in FIG. 1, but FIG. 2 also shows the additional elements of the network that are employed to connect to telephone networks and transport audio and video messages.

A variety of client devices such as fixed telephone terminals 220 or mobile devices 210 can be employed to send and receive audio and video messages. The messages can then be transferred to the client access point 100 using a direct wired connection 225 or using a wireless connection 215. In the present invention, the use of separate billing accounts and separate electronic mailboxes enables multiple users to share a single terminal 220 or mobile device 210. Conversely, a single user may also operate multiple terminals 220 or mobile devices 210.

As previously described in FIG. 1, the messages stored in the client access point 100 are transferred to mobile access point 110 via wireless connection 235. The message information is then transferred to hub access point 120 via another wireless connection 245.

A unique aspect of the present invention is hub voicemail server 230, which serves as the link between the local hub access point 120 and devices located anywhere on the local or global telephone network. One purpose of the hub voicemail server 230 is to record and store messages that are placed from any device 280, 290, 260, 270 on the telephone network 240, 250. These messages are then sent as digitized audio or video files to final destinations at client devices 210, 220. A second function of the hub voicemail server is to store audio or video messages that originate from client devices 210, 220 and subsequently play or stream these messages to client devices 280, 290, 260, 270 on the telephone network.

Hub voicemail server 230 contains a telephone modem that enables placing and receiving telephone calls to a conventional Plain Old Telephone System (POTS) network 250. Client devices on the POTS network can be conventional wired telephones 260 or can be wireless mobile telephone devices 270.

As an alternative to conventional telephone networks, audio or video messages can also be transferred via Internet Protocol (IP) and IP network 240 to telephone and terminals 280, 290 that are enabled to send and receive IP data. These “Ethernet” or “IP” telephones can connect to the IP network 240 via a wired Ethernet connection 277 or wirelessly via one of several IP protocols 267, such as Wi-Fi (IEEE 802.11). Although not shown in FIG. 2, several Client Access Points 100 may be located in proximity to each other to allow messages to be relayed from one to the other, thus enabling service to a much larger geographical area.

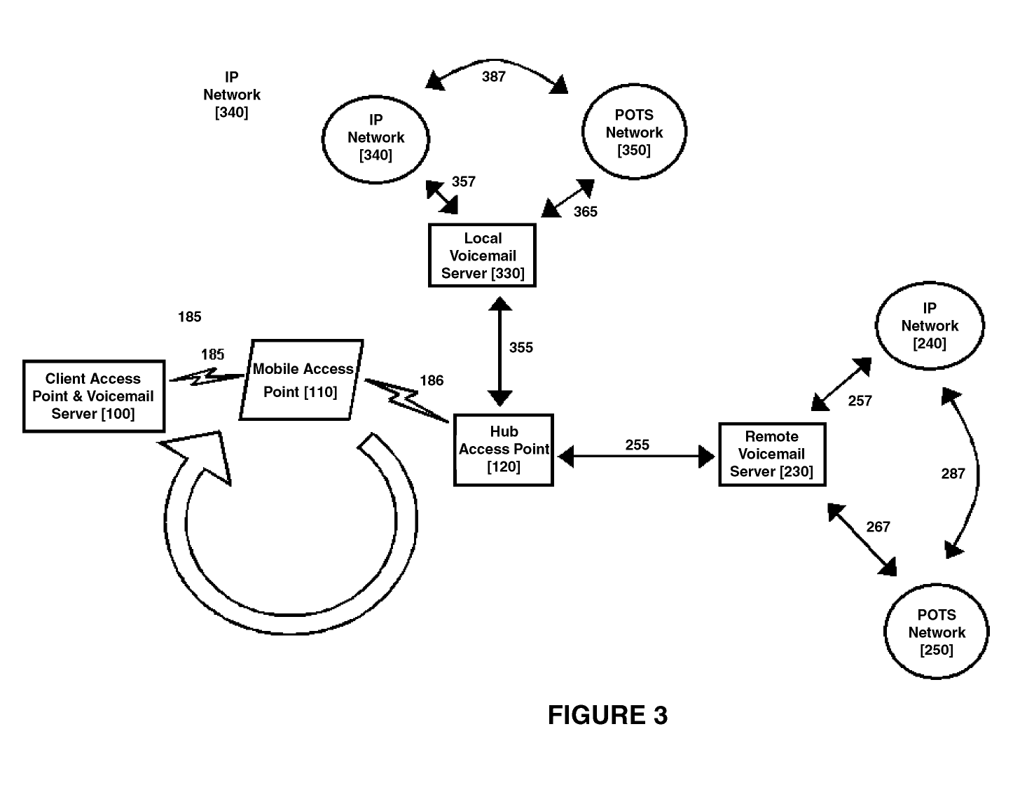

FIG. 3 illustrates an embodiment of the present invention that makes use of two separate voicemail servers 230, 330. For the purpose of clarity, the client devices are not shown in the figure. In this embodiment, voicemail server 330 is employed as a local server that is used to receive and send local telephone calls, and may be located in the same geographical area as the hub access point 120. Audio or video messages intended for recipients outside the local area are sent via the Internet connection 225 to a remote voicemail server 230 that can be used to send and receive telephone calls to client devices in other geographic regions.

The local and/or remote voicemail server may also deliver the messages originating from the Client Access Points 100 to conventional wired phones 260 and/or wireless mobile telephone devices 270 on the POTS network 250 through the use of the IP network interface 287. A number of global standards, such as Voice Over IP (VoIP), can be used to electronically encode the voice signal for transport across the digital networks.

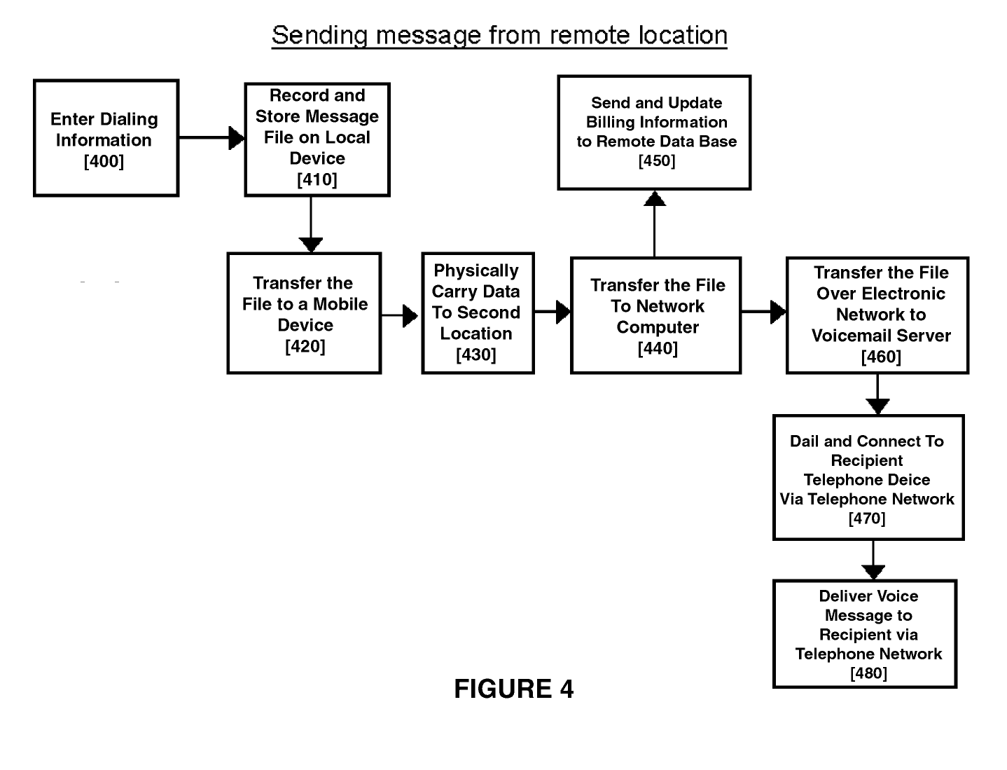

FIG. 4 illustrates the method used to send an audio or video message from a remote client device to a client device on a conventional telephone network. The first step 400 consists of entering the user ID information and recipient information into a client device. The user's individual billing and accounting information may also be displayed. The use of individual account and billing information enables multiple users to share the same set of client terminals. Conversely, it is also possible for a user to possess more than one account regardless of the number of client devices available. The user ID information enables each user to maintain individual billing accounts even though the same client device may be shared among multiple users. In the next step 410, the user then records and stores the message onto the client device. In the simplest embodiment, the client device can be contained in the client access point 100, which allows the user to record or playback messages. In another embodiment, the client device can be in the form of a separate terminal 210, 220 that communicates with the Client Access point 100 via a wireless or wired connection. In yet another embodiment, the client device can be a simple POTS network telephone that connects to a telephone jack provided by Client Access Point 100.

The message data is then transferred by wired or wireless connection to a mobile device in step 420. The mobile device then physically carries the data to another location that is proximate to a data network in step 430. The message file is then transferred to an electronic device that is connected to the data network, shown as step 440. At this point 450 the billing and accounting information is sent to a remote and centralized database. The message file is transferred to the voicemail or video-mail server shown as step 460. The file server device then dials and connects to the appropriate telephone device on the telephone network, shown as step 470.

Equivalently, the file server can also connect to a specific telephone device using the IP network and Voice over IP (VoIP) protocol. As the final step 480, shown in FIG. 4, the message is delivered to the intended recipient. Although not shown explicitly, step 480 may also consist of several smaller steps that comprise listening for an answering machine or live person, playing a message greeting, offering the user an interactive menu of playback options, and offering a method of recording a reply message in response to the original message.

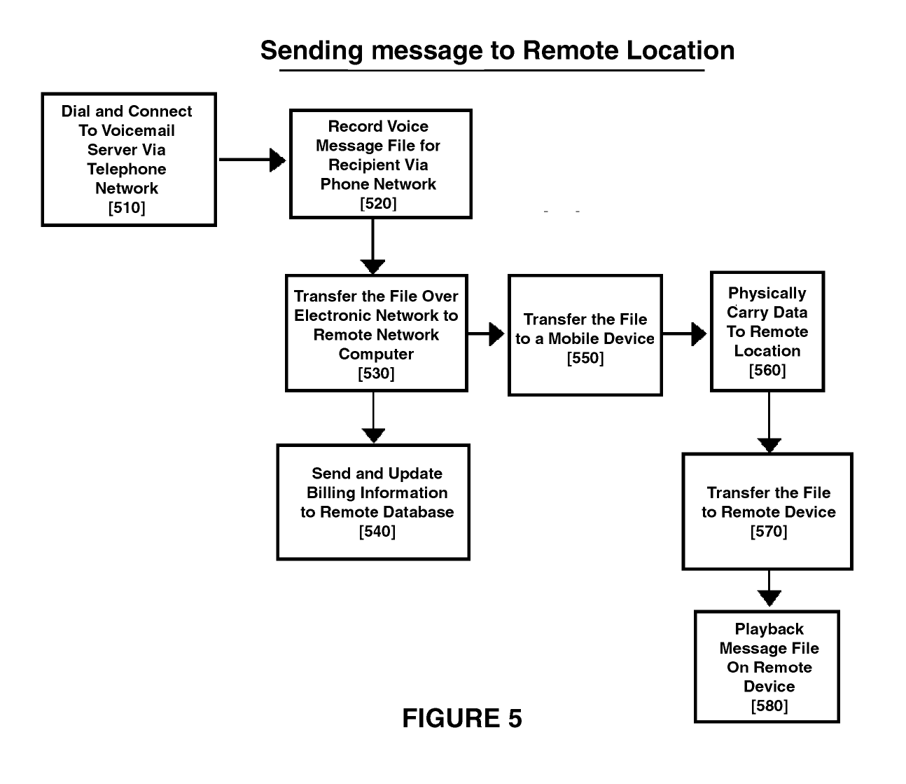

FIG. 5 outlines the basic method used to send a message from a standard telephone network to a client device at a remote location. This process is essentially the reverse of the process shown in FIG. 4. In the first step 510, the user dials the recipient telephone number and ID code, in a manner similar to placing a conventional telephone call or pager call. Accounting and billing information may also be provided to the user, and a user may possess more than one account. In step 520, the file server answers this phone call and the voice or video message is recorded onto the file server. In the next step 530, billing and accounting information is sent via the Internet to a centralized database for the purpose of accounting. In parallel, the message is sent via the Internet to another computer located at the remote location in step 540. The message file is then stored until it can be picked up by a mobile access point device 110. When the mobile access point 110 come in range, the data is automatically transferred to the mobile device in step 550. The mobile access point 110 then physically transports the data to the specific remote location in step 560. When the mobile access point comes within range of the specific recipient access point 100, the data is wirelessly and automatically delivered to the access point 100, as step 570.

As final step 580, the recipient can play back the received message using a client device. In the simplest embodiment, the client device can be a message playback module contained in the client access point 100. In other embodiments, the client device may be a portable computer or telephone that communicates with the client access point via a wired or wireless connection. In these additional embodiments, the communication between the client device and the client access point can employ internet protocols, such as Voice over IP (VoIP), or employ a standard POTS telephone connection used by conventional corded or cordless telephones.

Although FIGS. 1-5 represent exemplary embodiments of the present invention, there are certainly many alternative embodiments which exploit the underlying concepts disclosed in the present invention. The key elements of the present invention, which include the wireless data transport, physical transport, and voicemail server, thus form an electronic data transport network capable of sending and receiving audio and video messages without the need for a real-time data network between the sender and recipient. Furthermore, the present invention has the added advantages of being simple to use, having relatively low-power power consumption, and relatively low-cost to install and maintain.

What is claimed is:

1. A system for transporting electronic data, the system comprising:
(a) a mobile access point, the mobile access point comprising a communication module for wirelessly and bi-directionally communicating with client devices in proximity thereto; and
(b) a carrier for moving the mobile access point over a route which encompasses one or more client devices; and
(c) a file server providing a means to process the electronic data files transported via said mobile access point and providing a means of communicating with telephone devices via a separate electronic network.

2. The system of claim 1, wherein the electronic data comprises an audio message.

3. The system of claim 1, wherein the electronic data comprises a video message.

4. The system of claim 1, wherein the system also comprises a means of measuring the amount of data transported in the network and also measuring the number of messages transported in the network.

5. The system of claim 1, wherein the system also comprises a means of billing and payment.

6. The system of claim 2, wherein said separate electronic network comprises a POTS (Plain Old Telephone Service) network.

7. The system of claim 2, wherein said separate electronic network comprises an IP (Internet Protocol) network.

8. The system of claim 2, wherein said client devices are comprised of at least one mobile computer.

9. The system of claim 2, wherein said client devices are comprised of at least one access point.

10. The system of claim 2, wherein said client devices are comprised of at least one mobile IP telephone.

11. The system of claim 2 wherein at least one of said client devices is comprised of an access point containing a telephone jack disposed for electrical connection to a corded or cordless telephone.

12. The system of claim 1, wherein said mobile access point is configured to employ a short-range radio link of no greater than 2,000 meters.

13. A method for transporting electronic data, the method comprising the steps of:
(a) recording an electronic message into a client device;
(b) employing a mobile access point that traverses a route encompassing at least one said client device and able to wirelessly and bi-directionally transfer data with proximate said client device; and
(c) employing a file server providing a means to process said electronic data and communicate with telephone devices via a separate electronic network.

14. The method of claim 13, wherein said electronic data comprises an audio message.

15. The method of claim 13, wherein said electronic data comprises a video file.

16. The method of claim 13, further comprising the step of providing a means of billing and payment.

17. The method of claim 14, wherein said separate electronic network includes a POTS (Plain Old Telephone Service) network.

18. The method of claim 14, wherein said separate electronic network includes the Internet.

19. A method for transporting electronic data, the method comprising the steps of:
(a) establishing a telephone connection to a file server;
(b) recording an electronic message to said file server;
(c) transferring said electronic message from said file server to a hub access point;
(d) employing a mobile access point that communicates with said hub access point and traverses a route encompassing at least one client device and able to wirelessly and bi-directionally transfer data with proximate said client device; and
(e) employing said client device to retrieve and replay said electronic message.

20. The method of claim 19, wherein said electronic data comprises an audio message.

21. The method of claim 19, wherein said electronic data comprises a video file.

22. The method of claim 19, further comprising the step of providing a means of billing and payment.

23. The method of claim 20, wherein said telephone connection is placed over a POTS (Plain Old Telephone Service) network.

24. The method of claim 20, wherein said telephone connection is placed over an IP (Internet Protocol) network.

25. The method of claim 20, wherein said client device is a mobile computer.

26. The method of claim 20, wherein said client device is a mobile phone.
